(19) United States
(12) Patent Application Publication
(10) Pub. No.: US 2011/0137803 A1
(43) Pub. Date: Jun. 9, 2011

(54) SECURE ELECTRONIC RECEIPT SYSTEMS AND METHODS

(75) Inventor: Bruce Willins, E. Northport, NY (US)

(73) Assignee: Symbol Technologies, Inc.

(21) Appl. No.: 12/630,215

(22) Filed: Dec. 3, 2009

(51) Int. Cl. H04L 9/32; G06Q 40/00; G06Q 20/00; G06Q 30/00; G06Q 10/00; G06F 17/00

(52) U.S. Cl. 705/67; 705/17; 705/21; 705/317; 705/318; 726/27; 713/150; 235/382; 235/492

(57) ABSTRACT

The present disclosure relates to secure electronic receipt systems and methods. The present invention removes the need for paper-based receipts while preserving security through use of a digital signature on each electronic receipt verifying the transaction and other data related to the transaction. In an exemplary embodiment, the present invention includes a trusted email server, an authentication server, a point-of-sale (POS) terminal or the like, and a smart card or the like. A buyer can utilize the smart card to instruct the terminal to provide an electronic receipt. The terminal can utilize the trusted email server and the authentication server to digitally sign the electronic receipt with credentials trusted by the buyer, and these credentials can later be utilized to verify the electronic receipt.

### FIELD OF THE INVENTION

The present invention relates generally to receipts associated with various sales and transactions, and more particularly to secure electronic receipt systems and methods through a secure certificate.

### BACKGROUND OF THE INVENTION

In various transactions for goods and services, receipts are a written acknowledgement that a specified article or sum of money has been received as an exchange for the goods or services. The receipt can act as the title to the property obtained in the exchange. Conventional systems and methods almost exclusively rely on paper receipts. Paper receipts are not environmentally friendly, are often lost or thrown out, and can logistically difficult to manage. Electronic receipts via email are becoming more commonplace but adoption is often limited by the inability of individuals to verify in real-time that a receipt was delivered and that the receipt contains valid information.

### BRIEF SUMMARY OF THE INVENTION

In an exemplary embodiment, an electronic receipt method includes processing a transaction responsive to input from a buyer; providing data associated with the transaction and the input to a server; receiving a signed electronic receipt from the server; and providing the signed electronic receipt to the buyer, wherein the signed electronic receipt includes real-time, non-reputable transaction related information. The electronic receipt method further includes, by the server, verifying a seller associated with the data prior to the server providing the signed electronic receipt, wherein the seller is verified through a certificate associated with the seller. The signed electronic receipt includes the data associated with the transaction including description of goods or services, seller information, and amount tendered, and wherein the signed electronic receipt further includes a certificate. The electronic receipt method further includes, by the buyer, validating the transaction through an operation over a secure link with the server utilizing the certificate. The buyer has a verified certificate or a public key of the server, and wherein the operation includes a public key operation verifying the server has validated the transaction. Providing the signed electronic receipt includes transmitting the signed electronic receipt to a smart card of the buyer. The smart card communicates to a terminal for receiving the signed electronic receipt through one of a high-frequency contactless link or a Bluetooth link. The smart card includes circuitry configured to store the signed electronic receipt and a display configured to visually display data associated with the signed electronic receipt, and wherein the smart card further includes a tamper responsive grid preventing unauthorized access to cryptographic keys stored in the circuitry. Optionally, providing the signed electronic receipt includes transmitting the signed electronic receipt to a mobile device of the buyer. The electronic receipt method further includes, by the buyer, validating the transaction through an operation by the mobile device with the server utilizing a certificate associated with the signed electronic receipt. The buyer has a verified certificate or a public key of the server, and wherein the operation includes a public key operation verifying the server has validated the transaction.

In another exemplary embodiment, a method of providing secure electronic receipts includes receiving digitally signed data with a private key, wherein the data includes transaction data between a buyer and a seller; verifying the digitally signed data originated from a trusted seller; signing the digitally signed data with a trusted private key; and sending the digitally signed data with the trusted private key to one of the seller or the buyer. The method further includes providing a public key to the buyer; and verifying the digitally signed data with the trusted private key through an operation with the public key. The method further includes registering the buyer with associated data including the buyer's email address; and sending the digitally signed data with the trusted private key as an electronic receipt to the buyer's email address.

In yet another exemplary embodiment, a system providing secure electronic receipts includes a network interface; a processor communicatively coupled to the network interface; wherein the processor is configured to: receive transaction data associated with a sale between a seller and a buyer; verify the seller associated with the sale; digitally sign an electronic receipt based on the transaction data; and verify the electronic receipt. The system further includes a point-of-sale terminal associated with the seller connected to the network interface through a network. The system further includes a smart card associated with the buyer, wherein the smart card is configured to communicate with the point-of sale terminal. The smart card is configured to provide data about the buyer to the point-of sale terminal, and wherein the point-of sale terminal is configured to send the data about the buyer and the transaction data to the network interface. The point-of sale terminal is configured to receive the electronic receipt from the network interface and to transmit the electronic receipt to the smart card.

### BRIEF DESCRIPTION OF THE DRAWINGS

The present invention is illustrated and described herein with reference to the various drawings, in which like reference numbers denote like method steps and/or system components, respectively, and in which:

FIG. 1 is a diagram of a system for providing secure electronic receipts between a buyer and seller according to an exemplary embodiment;

FIG. 2 is a flowchart of an electronic receipt method utilizing the system of FIG. 1 according to an exemplary embodiment;

FIG. 3 is a flowchart of another electronic receipt method between a seller and a buyer according to an exemplary embodiment;

FIG. 4 is a diagram of a smart card for use as an electronic receipt card according to an exemplary embodiment;

FIG. 5 is a block diagram of a server for use in the system of FIG. 1 to provide electronic receipts according to an exemplary embodiment; and

FIG. 6 is a block diagram of a mobile device for use in the system of FIG. 1 to provide electronic receipts according to an exemplary embodiment.

### DETAILED DESCRIPTION OF THE INVENTION

In various exemplary embodiments, the present invention relates to secure electronic receipt systems and methods. The present invention removes the need for paper-based receipts while preserving security through use of a digital signature on each electronic receipt verifying the transaction and other data related to the transaction. In an exemplary embodiment, the present invention includes a trusted email server, an authentication server, a point-of-sale (POS) terminal or the like, and a smart card or the like. A buyer can utilize the smart card to instruct the terminal to provide an electronic receipt. The terminal can utilize the trusted email server and the authentication server to digitally sign the electronic receipt with credentials trusted by the buyer, and these credentials can later be utilized to verify the electronic receipt.

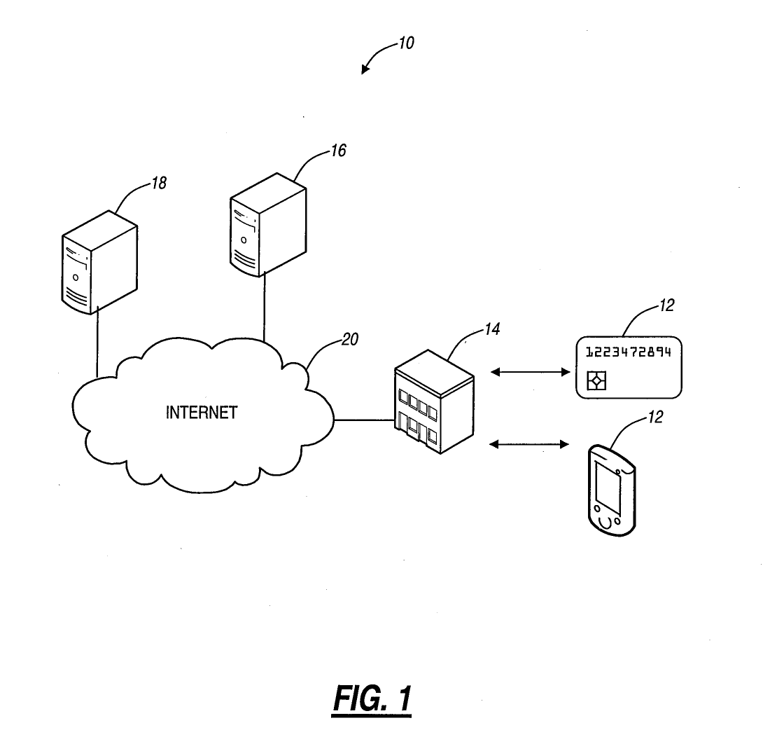

Referring to FIG. 1, in an exemplary embodiment, a system 10 is illustrated for providing secure electronic receipts. The system 10 includes an electronic receipt device 12, a terminal 14, an email server 16, and an authentication server 18. The receipt device 12 can be a low cost, passive or semi-passive smart card, electronic key fob, a mobile device such as a cell phone, smart phone, etc., and the like. Preferably, the receipt device 12 is a device typically carried with an individual. The receipt device 12 does not require direct connectivity to the Internet 20 but instead relies on an Internet connection provide via a terminal 14 such as a point-of-sale (POS) device or the like through a contact, a contactless-high frequency (HF) link, a radio frequency ID (RFID) link, a wireless local area network (WLAN) link, Bluetooth link, and the like. The receipt device 12 is configured to interact with the terminal 14 during a transaction to verify the validity of the retailer, to prompt an email receipt to an email account associated with the receipt device 12, and to verify the amount tendered in the email receipt along with other information is correct. As such, the receipt device 12 interacts with the terminal 14 to provide an electronic receipt to the individual. The terminal 14 as described herein includes any device configured to provide a sale transaction for goods and/or services. For example, the terminal 14 can include a POS device, a cash register, a computer, a web site, a mobile device, a credit card reader, and the like. The terminal 14 includes a connection to the Internet 20 as well as connectivity to the email server 14 and the authentication server 18, such as through the Internet 20.

The system 10 further includes the email server 16 and the authentication server 18 each shown connected to the terminal 14 through the Internet 20. Each of these servers 16, 18 is configured to interact with the receipt device 12 and the terminal 14 to provide a secure and verifiable electronic receipt of a transaction. Specifically, the email server 16 is configured to receive transaction-related information from the terminal 14 such as at the prompting of the receipt device 12 and to provide an email to a user based on the transaction-related information. The transaction-related information can include amount tendered by the buyer/seller, seller information, and descriptive information about the articles, goods, services received by the buyer. Also, the transaction-related information can include information identifying the buyer and/or user account information on the server 16. Also, the terminal 14 (i.e., from a merchant, seller, service provider, etc.) provides the server 16 information that is digitally signed using the merchant's private key and verifiable via a trusted certificate authority (CA). The server 16 can include a program to receive receipt-transaction information from merchants, to verify the merchant name and that the digital signature on all information conveyed has been signed by a trusted CA, and to verify that this information has been placed into a message or email in the user's (buyer's) account.

The authentication server 18 is configured to authenticate transactions based on keys associated with the terminal 14 and the receipt device 12. Collectively, the servers 16, 20 enable a buyer of goods or services to obtain real-time, non-reputable transaction information electronically without a paper receipt. The buyer can log into the servers 16, 20 anytime subsequent to the transaction through a secure link or the like and verify the transaction-related information thus ensuring the transaction is verified and trusted without a paper receipt. Note, the communications between the various devices over the Internet can be secure such as through Hyper Text Transport Protocol Secure (HTTPS), a Virtual Private Network (VPN), or the like.

The buyer can utilize the receipt device 12 to retrieve an electronic receipt. For example, the receipt device 12, as described above, can include a secure mobile device. The secure mobile device can display key information about the transaction validated by the trusted user-servers 16, 18 and communicated to the secure mobile device. Also, the secure mobile device can include a display and processing subsystem that is protected by a tamper responsive grid so that any effort to physically access the device will cause all cryptographic keys to be erased. This display and processing subsystem can be a cryptographic subsystem that contains a user's private Key (PKI), and the cryptographic subsystem of the device 12 can receive messages from the trusted server 16 and decrypt such message using the user's private key information (enabling only this device to interpret and display transaction information).

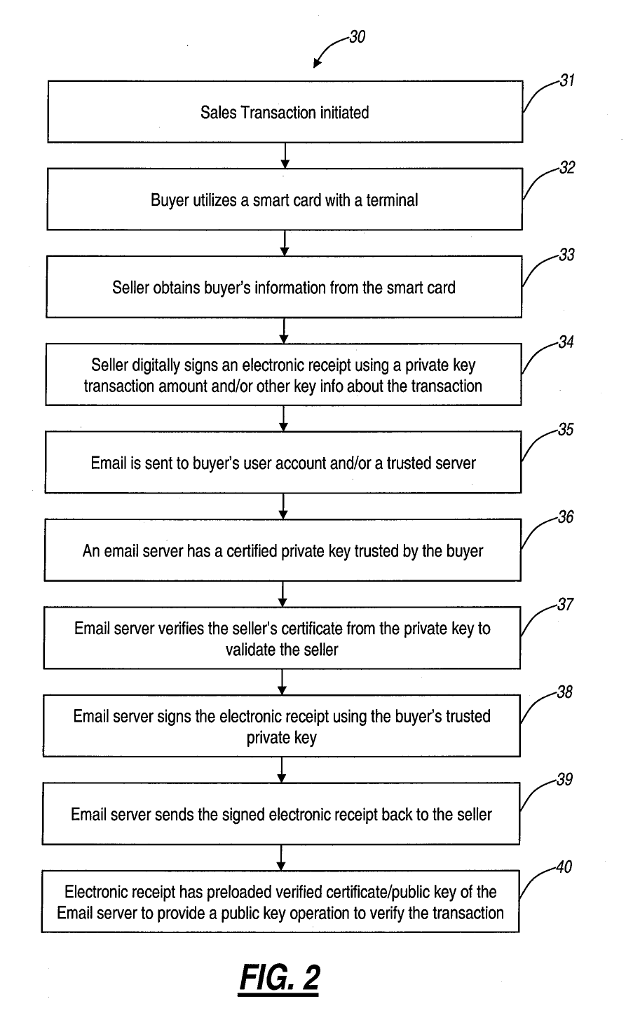

Referring to FIG. 2, in an exemplary embodiment, a flowchart illustrates an electronic receipt method 30 utilizing the system 10 of FIG. 1. In this exemplary embodiment, a sales transaction is initiated (step 31). The sales transaction can be for anything, i.e. goods, services, a combination thereof, etc., and generally involves two parties, i.e. a seller and a buyer. These two parties can be individuals, companies, etc. At this stage of the electronic receipt method 30, the seller has initiated the transaction (e.g., rang up goods/services, entered data into a terminal/cash register, etc.), such as through the terminal 14 in FIG. 1, and entered data concerning the transaction. For example, this can include scanning a bar code or the like on a product. Here, the terminal includes all of the data for the transaction, such as a sales price, data/time, description of the goods and/or services, seller data, etc. The buyer utilizes a smart card with a terminal (step 32). The method 30 is described with reference to a smart card for illustration purposes, and the method 30 could be utilized with any receipt device such as described in FIG. 1. The seller obtains the buyer's information from the smart card (step 33). With this information, the seller (i.e., the terminal associated with the seller) digitally signs an electronic receipt using a private key transaction amount and/or other key info about the transaction (step 34).

This digitally signed electronic receipt is sent to the buyer's user account and/or a trusted server (step 35). Here, the electronic receipt can be sent to the buyer's account (e.g., on the email server) or to the email server/authentication server with the digital signature via email or some other mechanism. This email can be to an email server for purposes of verifying the validity of the seller through the seller's digital signature. The email server has a certified private key trusted by the buyer (step 36). With this, the email server can verify the seller's certificate from the private key in the electronic receipt to validate the seller (step 37). The email server signs the electronic receipt using the buyer's trusted private key (step 38). The email server can then send the signed electronic receipt back to the seller (step 39). The electronic receipt now has a preloaded verified certificate/public key of the email server allowing a public key operation to verify the transaction (step 40). The seller can provide this electronic receipt signed by the email server to the buyer, and the buyer can later verify the transaction through a public key operation with the email server that is quick and efficient (versus a private key transaction). For example, the seller can provide the electronic receipt to the buyer through a contact, a contactless-HF link, a RFID link, a WLAN link, and the like. Alternatively, the seller can email the buyer offline. For example, the smart card can provide the buyer's email address which receives the signed electronic receipt. Alternatively in step 39, the email server can send the signed electronic receipt directly to the buyer, e.g. through email, instant message, etc.

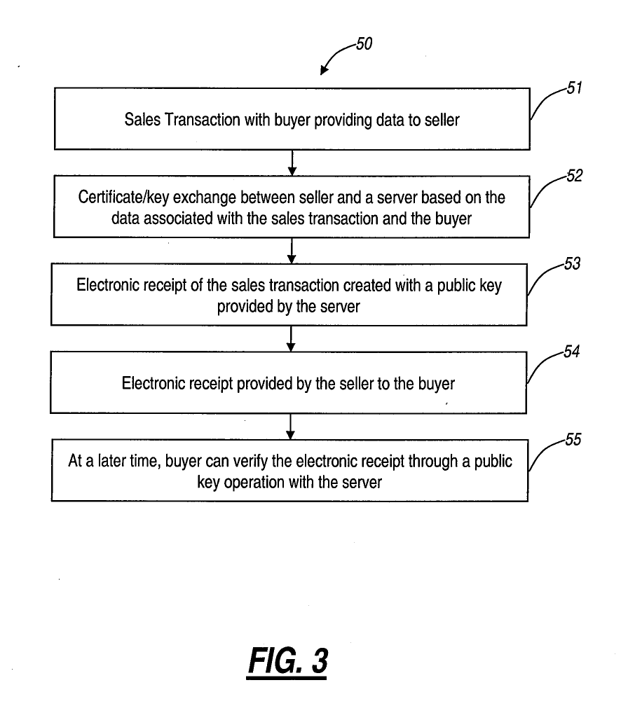

Referring to FIG. 3, in another exemplary embodiment, a flowchart illustrates an electronic receipt method 50 between a seller and a buyer. In the method 50, a sales transaction occurs between the buyer and the seller with the buyer providing data to the seller (step 51). This data can include anything that can uniquely identify the buyer and provide information about the buyer. For example, the buyer can provide credit card info, banking info, an email address, an account associated with an electronic receipt or email server, and the like. This step of providing data can occur in any format, including swiping a card, contacting an RFID or HF device to a contact, placing an RFID or HF device in proximity of a reader, entering data through a computer or web site, orally providing the information, and the like. Once this data is provided by the buyer and the seller has data associated with the sales transaction (e.g., price, date/time, description of goods/services, terms of sale, warranty information, etc.), there is a certificate/key exchange between the seller and a server (e.g., the electronic receipt or email server) based on the data associated both with the buyer and the sales transaction (step 52). The server is configured to create a public key based on the certificate/key exchange, and this public key is utilized to create an electronic receipt (step 53). Specifically, the electronic receipt can include all of the data associated with the sales transaction along with the public key. In an exemplary embodiment, the server creates the public key and provides it to the seller who in turn creates the electronic receipt including the public key. The electronic receipt is provided to the buyer by the seller (step 54). This can be through any mechanisms know in the art such as email, direct to a smart card through a contact or HF link, instant message, twitter message (using www.twitter.com), and the like. At any later time, the buyer can verify the electronic receipt through a public key operation with the server.

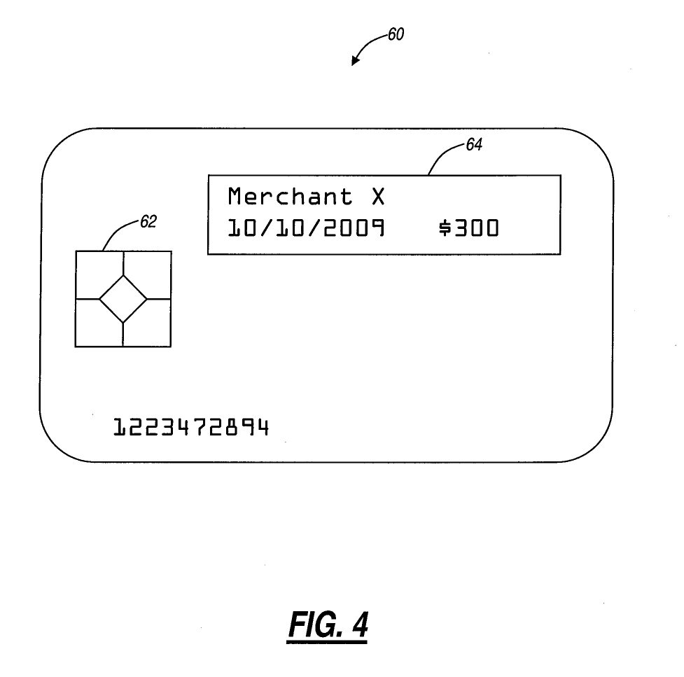

Referring to FIG. 4, in an exemplary embodiment, a smart card 60 is illustrated for use as an electronic receipt card. The smart card 60 can have dimensions substantially similar to known credit cards, automated teller machine (ATM) cards, debit cards, and the like. Thus, the smart card 60 can be carried with an individual in a purse, wallet, etc. The smart card 60 includes embedded integrated circuits 62 for data storage, communication, and processing and an electronic paper display 64 for displaying information to a user. The circuits 62 can include a power supply such as a battery, circuitry for HF or RFID communications, circuitry for providing data communications to/from a reader or terminal, and circuitry to enable the display 64. As described herein, the smart card 60 is configured to communicate data about its owner to a terminal, i.e. email address, account information, other contact information, etc. This data is then used by the terminal to create a secure electronic receipt for an associated transaction. This receipt can be transmitted and stored in the smart card 60 through the circuits 62. Further, the smart card 60 can later download receipts to a computer or the like through an associated reader such as a USB-based RFID/HF reader and associated software.

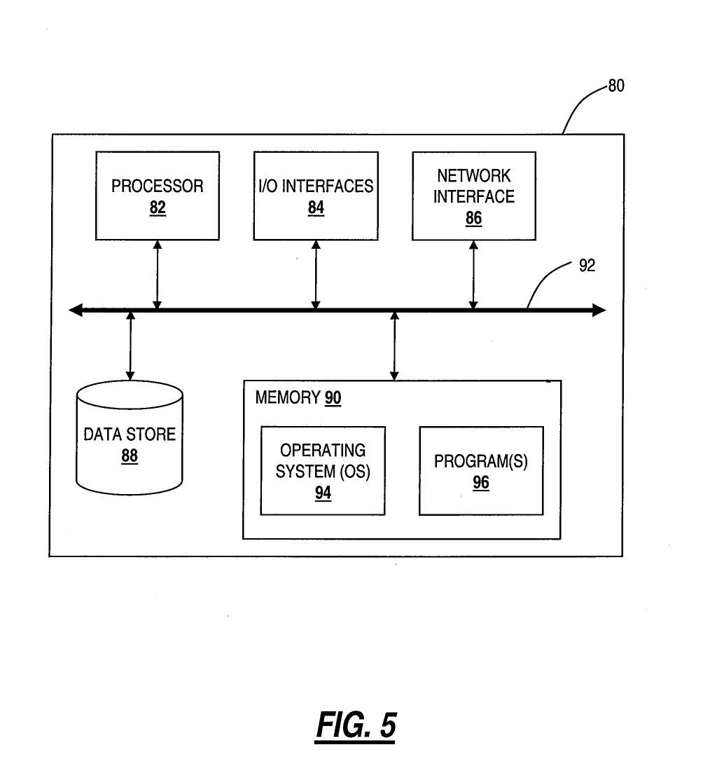

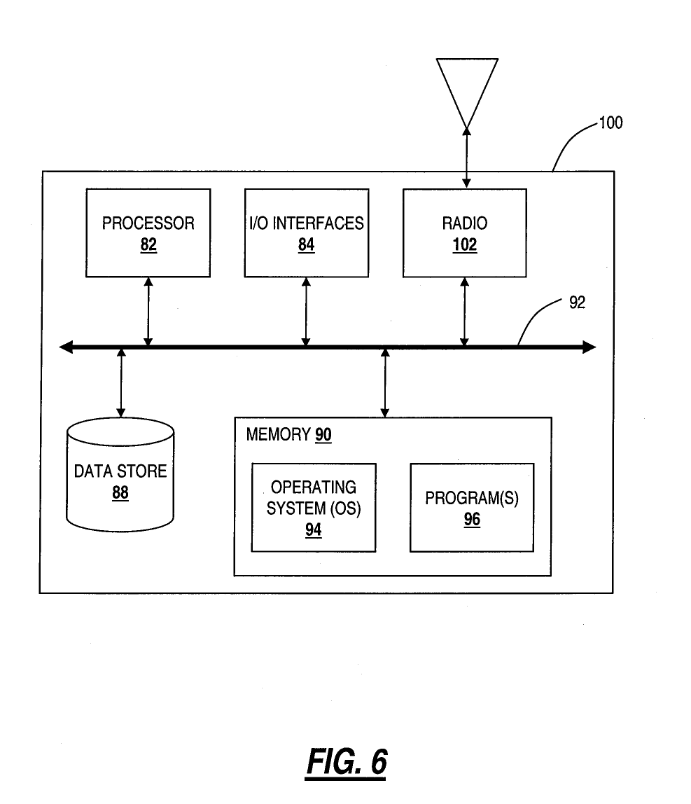

Referring to FIGS. 5 and 6, in exemplary embodiments, a server 80 and a mobile device 100 are illustrated for use in the system 10 to provide electronic receipts. As described herein, the server 80 can be the email server 16, the authentication server 18, and the like. The server 80 can be a digital computer that, in terms of hardware architecture, generally includes a processor 82, input/output (I/O) interfaces 84, a network interface 86, a data store 88, and memory 90. The components (82, 84, 86, 88, and 90) are communicatively coupled via a local interface 92. The local interface 92 can be, for example but not limited to, one or more buses or other wired or wireless connections, as is known in the art. The local interface 92 can have additional elements, which are omitted for simplicity, such as controllers, buffers (caches), drivers, repeaters, and receivers, among many others, to enable communications. Further, the local interface 92 can include address, control, and/or data connections to enable appropriate communications among the aforementioned components.

The processor 82 is a hardware device for executing software instructions. The processor 82 can be any custom made or commercially available processor, a central processing unit (CPU), an auxiliary processor among several processors associated with the server 80, a semiconductor-based microprocessor (in the form of a microchip or chip set), or generally any device for executing software instructions. When the server 80 is in operation, the processor 82 is configured to execute software stored within the memory 90, to communicate data to and from the memory 90, and to generally control operations of the server 80 pursuant to the software instructions. The I/O interfaces 84 can be used to receive user input from and/or for providing system output to one or more devices or components. User input can be provided via, for example, a keyboard and/or a mouse. System output can be provided via a display device and a printer (not shown). I/O interfaces 84 can include, for example, a serial port, a parallel port, a small computer system interface (SCSI), an infrared (IR) interface, a radio frequency (RF) interface, and/or a universal serial bus (USB) interface.

The network interface 86 can be used to enable the server 80 to communicate on a network. For example, the server 80 can utilize the network interface 88 to communicate to with remote networks, such as a wireless network, a hosted wireless network, and the like. The network interface 86 can include, for example, an Ethernet card (e.g., 10 BaseT, Fast Ethernet, Gigabit Ethernet) or a wireless local area network (WLAN) card (e.g., 802.11a/b/g). The network interfaces 86 can include address, control, and/or data connections to enable appropriate communications on the network. A data store 88 can be used to store data. The data store 88 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 88 can incorporate electronic, magnetic, optical, and/or other types of storage media. In one example, the data store 88 can be located internal to the server 90 such as, for example, an internal hard drive connected to the local interface 92 in the server 80. Additionally in another embodiment, the data store can be located external to the server 80 such as, for example, an external hard drive connected to the I/O interfaces 84 (e.g., SCSI or USB connection). Finally in a third embodiment, the data store may be connected to the server 80 through a network, such as, for example, a network attached file server.

The memory 90 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 90 may incorporate electronic, magnetic, optical, and/or other types of storage media. Note that the memory 90 can have a distributed architecture, where various components are situated remotely from one another, but can be accessed by the processor 82. The software in memory 90 can include one or more software programs, each of which includes an ordered listing of executable instructions for implementing logical functions. In the example of FIG. 5, the software in the memory system 90 includes a suitable operating system (O/S) 94 and programs 96. The operating system 94 essentially controls the execution of other computer programs, and provides scheduling, input-output control, file and data management, memory management, and communication control and related services. The operating system 94 can be any of Windows NT, Windows 2000, Windows XP, Windows Vista (all available from Microsoft, Corp. of Redmond, Wash.), Solaris (available from Sun Microsystems, Inc. of Palo Alto, Calif.), or LINUX (or another UNIX variant) (available from Red Hat of Raleigh, N.C.).

For the email server 16, the programs 96 can include a management program and a communication program. As described herein, the email server 16 is configured to communicate to a seller and/or buyer to create a public key based on data associated with a sales transaction such as a private key, certificate, etc. The communication program can include software configured to interact with devices associated with the seller and/or buyer for communicating transaction data, keys, etc. The management program can include software configured to create electronic receipts with public keys based on the data associated with the transaction. Additionally, the management program can be configured to process public keys for verification of transactions based on the public key associated with an electronic receipt. The authentication server 18 can be integrated in the same server 80 as the email server or a separate server 80. The authentication server 18 can be a certificate authority (CA) that issues digital certificates for use by other parties such as the buyer and seller. Additionally, the servers 16, 18 can include registration and configuration applications in the programs 96. For example, a registration application can enable a user to sign up for electronic receipts by registering a device (e.g., smart card 60, mobile device, etc.) and assigning data to the device (e.g., contact info, email addresses, etc.). The configuration application can enable the user to set preferences, set alerts, managed existing receipts, etc.

In FIG. 6, the present invention can include a mobile device 100 with various components configured for electronic receipts. The mobile device 10 can be a digital device that, in terms of hardware architecture, includes many of the same components as the server 80. Specifically, the mobile device 100 generally includes the processor 82, input/output (I/O) interfaces 84, a data store 88, memory 90, and a radio 102. The radio 102 enables wireless communication to an external access device or network. Any number of suitable wireless data communication protocols, techniques, or methodologies can be supported by the radio 102, including, without limitation: RF; IrDA (infrared); Bluetooth; ZigBee (and other variants of the IEEE 802.15 protocol); IEEE 802.11 (any variation); IEEE 802.16 (WiMAX or any other variation); RFID; HR; Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. With respect to the operating system 94 for the mobile device 100, the operating system 94 can be any of LINUX (or another UNIX variant), Android (available from Google), Symbian OS, Microsoft Windows CE, iPhone OS (available from Apple, Inc.), Palm OS, Blackberry OS, and the like.

The mobile device 100 can be utilized in place of the smart card 60 by a buyer. Specifically, the mobile device 100 can be configured to communicate with the terminal 14 to provide information regarding the buyer to the seller to enable creation of an electronic receipt. Thus, the mobile device 100 can include a receipt program in the programs 96 that enable communication with the terminal 14 and that stores/manages electronic receipts. The mobile device 100 can further include a graphical user interface (GUI) for display on the I/O interfaces 84 that can allow a user to view recent purchases and the associated electronic receipts.

In addition to providing secure and verifiable electronic receipts, the present invention can be extended to further provide value transfers for the associated transactions. For example, the servers 16, 18 can be interfaced to a bank, an automated clearing house (ACH) network, a credit card processing system, and the like. This could enable cash or equivalent to be exchanged between the buyer and seller as part of the secure electronic receipt processes described herein.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. An electronic receipt method, comprising:
processing a transaction responsive to input from a buyer;
providing data associated with the transaction and the input to a server;
receiving a signed electronic receipt from the server; and
providing the signed electronic receipt to the buyer, wherein the signed electronic receipt comprises real-time, non-reputable transaction related information.

2. The electronic receipt method of claim 1, further comprising:
by the server, verifying a seller associated with the data prior to the server providing the signed electronic receipt, wherein the seller is verified through a certificate associated with the seller.

3. The electronic receipt method of claim 1, wherein the signed electronic receipt comprises the data associated with the transaction including description of good or services, seller information, and amount tendered, and wherein the signed electronic receipt further comprises a certificate.

4. The electronic receipt method of claim 3, further comprising:
by the buyer, validating the transaction through an operation over a secure link with the server utilizing the certificate.

5. The electronic receipt method of claim 4, wherein the buyer has a verified certificate or a public key of the server, and wherein the operation comprises a public key operation verifying the server has validated the transaction.

6. The electronic receipt method of claim 1, wherein providing the signed electronic receipt comprises transmitting the signed electronic receipt to a smart card of the buyer.

7. The electronic receipt method of claim 6, wherein the smart card communicates to a terminal for receiving the signed electronic receipt through one of a high-frequency contactless link or a Bluetooth link.

8. The electronic receipt method of claim 7, wherein the smart card comprises circuitry configured to store the signed electronic receipt and a display configured to visually display data associated with the signed electronic receipt, and wherein the smart card further comprises a tamper responsive grid preventing unauthorized access to cryptographic keys stored in the circuitry.

9. The electronic receipt method of claim 1, wherein providing the signed electronic receipt comprises transmitting the signed electronic receipt to a mobile device of the buyer.

10. The electronic receipt method of claim 9, further comprising:
by the buyer, validating the transaction through an operation by the mobile device with the server utilizing a certificate associated with the signed electronic receipt.

11. The electronic receipt method of claim 10, wherein the buyer has a verified certificate or a public key of the server, and wherein the operation comprises a public key operation verifying the server has validated the transaction.

12. A method of providing secure electronic receipts, comprising:
receiving digitally signed data with a private key, wherein the data comprises transaction data between a buyer and a seller;
verifying the digitally signed data originated from a trusted seller;
signing the digitally signed data with a trusted private key; and
sending the digitally signed data with the trusted private key to one of the seller or the buyer.

13. The method of claim 12, further comprising:
providing a public key to the buyer; and
verifying the digitally signed data with the trusted private key through an operation with the public key.

14. The method of claim 12, further comprising:
registering the buyer with associated data comprising the buyer's email address; and
sending the digitally signed data with the trusted private key as an electronic receipt to the buyer's email address.

15. A system providing secure electronic receipts, comprising:
a network interface;
a processor communicatively coupled to the network interface;
wherein the processor is configured to:
receive transaction data associated with a sale between a seller and a buyer;
verify the seller associated with the sale;
digitally sign an electronic receipt based on the transaction data; and
verify the electronic receipt.

16. The system of claim 15, further comprising a point-of-sale terminal associated with the seller connected to the network interface through a network.

17. The system of claim 16, further comprising a smart card associated with the buyer, wherein the smart card is configured to communicate with the point-of sale terminal.

18. The system of claim 17, wherein the smart card is configured to provide data about the buyer to the point-of sale terminal, and wherein the point-of sale terminal is configured to send the data about the buyer and the transaction data to the network interface.

19. The system of claim 18, wherein the point-of sale terminal is configured to receive the electronic receipt from the network interface and to transmit the electronic receipt to the smart card.
